(19) United States
(12) Patent Application Publication
(10) Pub. No.: US 2020/0150576 A1
(43) Pub. Date: May 14, 2020

(54) Image Forming System, Image Forming Method, Image Forming Program, And Image Inspection Device

(71) Applicant: Konica Minolta, Inc., Tokyo (JP)

(72) Inventor: Yoshiyuki SUWA, Tokyo (JP)

(73) Assignee: Konica Minolta, Inc., Tokyo (JP)

(21) Appl. No.: 16/676,616

(22) Filed: Nov. 7, 2019

(30) Foreign Application Priority Data
Nov. 9, 2018 (JP) 2018-211672

(51) Int. Cl. G03G 15/00

(52) U.S. Cl. CPC G03G 15/5062

(57) ABSTRACT

An image forming system includes an image forming apparatus including an image former that forms an image on a sheet of paper, and an image inspection device including a reader that reads the sheet of paper, and the image forming system includes a storage that stores information, and a hardware processor that causes the reader to read a pre-image formation paper to store information of a defect present on the pre-image formation paper in the storage as defect information, and causes the reader to read a post-image formation paper on which the image has been formed by the image former to perform quality determination on a basis of the defect information.

This application claims priority to Japanese Patent Application No. 2018-211672, filed on Nov. 9, 2018, the entire disclosure of which is incorporated herein by reference.

### BACKGROUND

### Technological Field

The present invention relates to an image forming system, an image forming method, an image forming program, and an image inspection device.

### Description of the Related Art

Image forming systems including an image inspection device for checking the image quality after printing are known in the related art. In an image forming system including an image inspection device, there is also known technology for discriminating whether a defect detected by the image inspection device is attributable to paper as a print medium or to printing having occurred upon printing.

For example, in JP 2017-161352 A, a sheet of paper including a printed image is read by an image reading device, and for a non-image area, it is determined whether a defect is attributable to the paper or the printing on the basis of paper defect data (density variations/color) that is registered in advance. For an image area, it is determined whether a defect is attributable to the paper or the printing on the basis of the paper defect data that is registered in advance and the defect determination data previously determined for the printing of the non-image area.

Included in JP 2005-205853 A are a pre-printing reader that reads a sheet of paper before printing and a post-printing reader that reads a sheet of printed paper. A defect attributable to printing is determined by determining image data of the pre-printing reader as a defect attributable to paper and removing the paper-attributable defect data from image data of the post-printing reader.

JP 2017-161352 A has a disadvantage that an erroneous determination is made when a paper defect changes depending on brands or manufacturing lots of the paper since the determination is based on the paper defect data that is registered in advance. Meanwhile, in JP 2017-161352 A, since a defect attributable to the paper and a defect attributable to printing are determined separately, determination as a defective product is made when there is a printing defect equivalent to a defect that has originally been on the paper. JP 2005-205853 A also determines a defect attributable to paper separately from a defect attributable to printing, determination as a defective product is made when there is a printing defect equivalent to a defect that has originally been on the paper.

However, in a case where a defect generated during printing is comparable to a defect that has originally been on the paper, this printed matter can be regarded as a good product. However, since a defect attributable to the paper and a defect attributable to printing are determined separately in the related art, even a printed matter that does not need to be regarded as being defective is determined as a defective product. As a result, a waste of paper, toner, and printing time for reprinting occurs.

### SUMMARY

Therefore, an object of the present invention is to provide an image forming system, an image forming method, an image forming program, and an image inspection device that can reduce defect determination that leads to a waste in image inspection after printing.

To achieve the abovementioned object, according to an aspect of the present invention, there is provided an image forming system including: an image forming apparatus comprising an image former that forms an image on a sheet of paper; and an image inspection device comprising a reader that reads the sheet of paper, and the image forming system reflecting one aspect of the present invention comprises: a storage that stores information; and a hardware processor that causes the reader to read a pre-image formation paper to store information of a defect present on the pre-image formation paper in the storage as defect information, and causes the reader to read a post-image formation paper on which the image has been formed by the image former to perform quality determination on a basis of the defect information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating a configuration of an image forming system according to an embodiment of the present invention;

FIG. 2 is a block diagram illustrating a configuration of the image forming system;

FIG. 3 is a flowchart illustrating a processing procedure of defect determination;

FIG. 4 is an explanatory diagram for explaining an exemplary defect present on unprinted paper;

FIG. 5 is an explanatory diagram explaining exemplary defect information;

FIG. 6 is an explanatory diagram for explaining an example how to determine whether a printed matter is a good product or a defective product;

FIG. 7 is an explanatory diagram for explaining defect information generated for each brand of paper;

FIG. 8 is a schematic diagram illustrating a configuration of an image forming system of a first variation;

FIG. 9 is a schematic diagram illustrating a configuration of an image forming system of a second variation;

FIG. 10 is a schematic diagram illustrating a configuration of an image forming system of a third variation;

FIG. 11 is a schematic diagram illustrating a configuration of an image forming system of a fourth variation;

FIG. 12 is a schematic diagram illustrating a configuration of an image forming system of a fifth variation; and

FIG. 13 is a schematic diagram illustrating a configuration of an image forming system of a sixth variation.

### DETAILED DESCRIPTION OF EMBODIMENTS

Hereinafter, one or more embodiments of the present invention will be described with reference to the drawings. However, the scope of the invention is not limited to the disclosed embodiments. Note that in the description of the drawings, the same components are denoted by the same symbol, and redundant descriptions are omitted. Dimension ratios of the drawings are exaggerated for convenience of explanation and may be different from the actual ratios.

### Embodiments

(Configuration of Image Forming System)

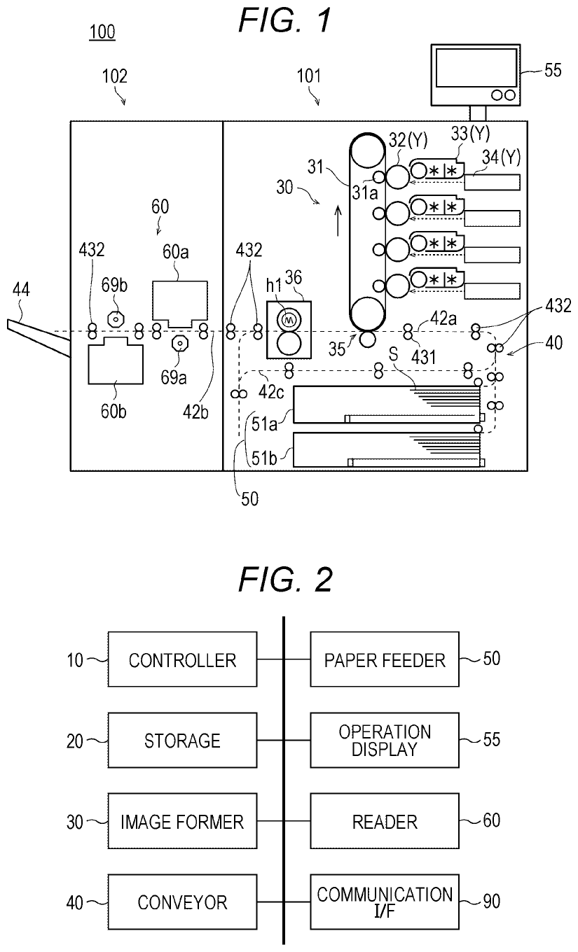

FIG. 1 is a schematic diagram illustrating a configuration of an image forming system according to an embodiment of the present invention. FIG. 2 is a block diagram illustrating a configuration of the image forming system.

An image forming system 100 includes an image forming apparatus 101 and an image inspection device 102. The image forming apparatus 101 forms an image (prints) on a sheet of paper (print medium). The image inspection device 102 reads a sheet of paper and generates image information.

As illustrated in FIG. 2, the image forming system 100 includes a controller 10, a storage 20, an image former 30, a conveyor 40, a paper feeder 50, an operation display 55 (display), a reader 60, and a communication. I/F (interface) 90. These components are connected to each other via a bus for exchanging signals thereamong.

The controller 10 is a CPU and forms a computer together with the storage 20. The controller 10 controls the respective components and performs various arithmetic processes in accordance with a program to perform printing on a sheet of paper and to perform quality determination

The storage 20 includes a ROM that stores various programs and various types of data in advance, a RAM that temporarily stores programs and various types of information as a work area, and a hard disk that stores various programs and various types of information.

The image former 30 forms an image by an electrophotographic approach. The image former 30 includes an intermediate transfer belt 31 (transfer body), photoreceptor drums 32, developers 33, a writer 34, a secondary transferer 35, and a fixer 36. The photoreceptor drums 32, the developers 33, and the writers 34 each include configurations corresponding to basic colors of yellow (Y), magenta (M), cyan (C), and black (K). In FIG. 1, only the symbols 32(Y), 33(Y), and 33(Y) corresponding to the photoreceptor drum 32, the developer 33, and the writer 34 for yellow are illustrated, and the other symbols are omitted to avoid complexity of the drawing.

The writers 34 expose surfaces of the charged photoreceptor drums 32 based on image data in a print job input from an external device to form electrostatic latent images. The developers 33 develop the formed electrostatic latent images by toners, and form toner images of the respective colors on the surfaces of the photoreceptor drums 32. The images formed by the toners of the respective colors on the surfaces of the photoreceptor drums 32 are sequentially superimposed on the intermediate transfer belt 31 as primary transfer to form a full-color toner image. This toner image is transferred onto a sheet of paper S by the secondary transferer 35 and then heated and pressurized by the fixer 36 to form a full-color image on the paper S.

In the present embodiment, at least one of a pair of the intermediate transfer belt 31 (transfer body) and the photoreceptor drums 32 (photoreceptors) or a pair of the photoreceptor drums 32 and the developers 33 can be separated from each other. This is to avoid toners from adhering to a sheet of paper when the unprinted paper passes through the image former 30. Since no toners adhere to the intermediate transfer belt 31 (transfer body) that comes into contact with a sheet of paper by allowing either pair of the intermediate transfer belt 31 (transfer body) and the photoreceptor drums 32 (photoreceptors) or the pair of the photoreceptor drums 32 and the developers 33 to be separated from each other, it is possible to prevent toners from adhering to the unprinted paper when the unprinted paper passes through the image former 30.

In order to separate the intermediate transfer belt 31 and the photoreceptor drums 32, for example, rollers 31a that press the intermediate transfer belt 31 toward the photoreceptor drums 32 are moved in a direction away from the photoreceptor drums 32. The rollers 31a are arranged to correspond to the photoreceptor drums 32 of the respective colors. In this manner, the intermediate transfer belt 31 can be separated from the photoreceptor drums 32.

In order to separate the photoreceptor drums 32 and the developers 33 from each other, for example, the developers 33 are all moved in a direction away from the photoreceptor drums 32. In this manner, the developers 33 can be separated from the photoreceptor drums 32.

Note that it is possible to avoid toners from adhering to the unprinted paper in the secondary transferer 35 by separating the intermediate transfer belt 31 and a corresponding roller. However, when the intermediate transfer belt 31 and the corresponding roller are separated from each other in the secondary transferer 35, there are cases where a sheet of paper cannot be conveyed depending on the installation interval of conveyance rollers (described later). For this reason, it is necessary to pay attention to the installation interval of the conveyance rollers so that the paper conveyance force is not lost in a case where the intermediate transfer belt 31 and the corresponding roller are separated.

The fixer 36 includes a hollow heating roller inside which a heater hl is arranged and a pressure roller facing the heating roller. The rollers are controlled to a predetermined temperature (for example, 100° C. or more) by the heater hl, and the paper S is heated and pressurized.

The conveyor 40 includes a registration roller 431 and a plurality of conveyance rollers 432 included in conveyance paths 42a to 42c and a drive motor (not illustrated) that drives these rollers. The conveyance paths 42a to 42c are connected to a paper ejecting tray 44. The conveyor 40 rotates the registration roller 431 and the plurality of conveyance rollers 432 at predetermined timing by the drive motor in accordance with an instruction from the controller 10, pulls out the paper S from the paper feeder 50, and conveys the paper S to the image former 30. The conveyance paths 42a to 42c include a paper feeding conveyance path 42a, a duplex printing conveyance path 42c, and a conveyance path 42b in the image inspection device 102. In FIG. 1, symbols 432 for the plurality of conveyance rollers are partially omitted.

The paper feeder 50 (first paper feeder) is included in the image forming apparatus 101. The paper S fed from the paper feeder 50 is conveyed along the paper feeding conveyance path 42a. In the paper feeding conveyance path 42a, the registration roller 431 that adjusts conveyance timing of papers by being rotated and stopped by a clutch is disposed.

The paper S conveyed along the paper feeding conveyance path 42a is formed with an image by the image former 30, passes through the downstream conveyance paths 42b and 42c, and then is ejected onto the paper ejecting tray 44.

When the print setting of the print job is duplex printing, the paper S on which the image is formed on one side (first side) is conveyed to the duplex printing conveyance path 42c below the image former 30. The paper S conveyed to the duplex printing conveyance path 42c is turned upside down by a switchback path, and then merges with the paper feeding conveyance path 42a. Then an image is formed on the other side (second side) of the paper S by the image former 30 again.

The operation display 55 includes a display including a touch panel, a numeric keypad, a start button, and a stop button and receives input of a brand or a production lot (paper group) of papers stored in the paper feeder 50 and input of various settings such as printing conditions. The operation display 55 is also used to display the state of the image forming system 100.

The reader 60 includes scanners 60a and 60b and is arranged so as to read images on different sides of the paper S with the conveyance path 42b interposed between the scanners 60a and 60b. The scanner 60a reads the upper side (first side) of the paper S, and the scanner 60b reads the lower side (second side). Therefore, both sides of the paper can be read by one time of conveyance. The scanners 60a and 60b are provided with back parts 69a and 69b at positions facing the scanners 60a and 60b, respectively, across the conveyance path 42b. The scanner 60a and the scanner 60b have the same configuration. The back part 69a and the back part 69b also have the same configuration.

The scanners 60a and 60b each include a line image sensor (for example, a contact line image sensor), a lens optical system, a light emitting diode (LED), and a housing for accommodating these components, and read a sheet of paper being conveyed as an image. Upon reading, light from the LEDs irradiate the first side and the second side of the paper S passing through reading positions on the conveyance path 42b at the scanners 60a and 60b. Then an image on each side of the paper S passing through the reading positions is guided by a lens optical system and formed on a line image sensor to be read. Note that only the scanner 60a may be provided to read the upper side of the paper S (first side, the printing side in the configuration of the present system).

The paper ejecting tray 44 receives the ejected paper S that has passed through the image inspection device 102.

The communication interface 90 is, for example, a network interface supporting standards such as SATA, PCI ExpreS, USB, Ethernet (registered trademark), and IEEE 1394, a wireless communication interface such as Bluetooth (registered trademark), IEEE 802.11, or other various local connection interfaces. A print job including print data and print settings from an external device (such as a computer or a portable terminal) is received through the communication interface 90.

(Defect Determination)

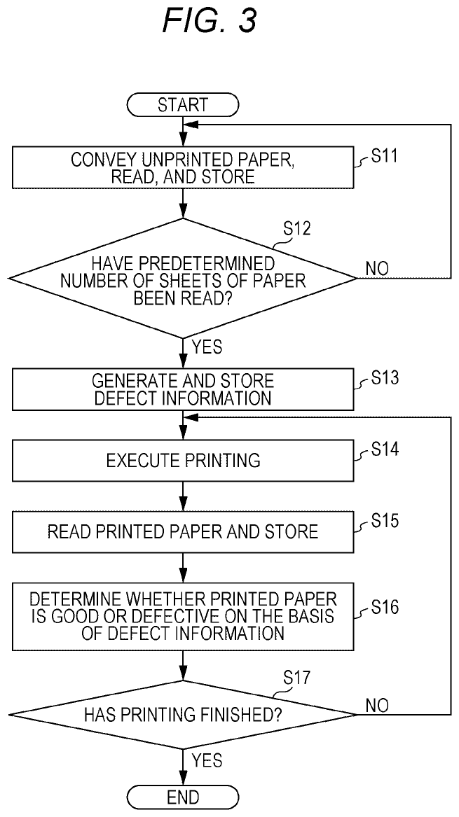

FIG. 3 is a flowchart illustrating a processing procedure of defect determination. This defect determination processing is performed by the controller 10 executing a program for performing the processing procedure (flowchart) described here.

The controller 10 first conveys one sheet of paper S (unprinted paper) from the paper feeder 50 to the paper ejecting tray 44 without causing the image former 30 to perform printing operation while causing the reader 60 to read both sides of the unprinted paper and stores obtained image information in the storage 20 (S11). At this point, at least one of the pair of the intermediate transfer belt 31 and the photoreceptor drums 32 or the pair of the photoreceptor drums 32 and the developers 33 is separated from each other. Note that in a case of a configuration that cannot be separated, this separation operation may not be performed.

Subsequently, the controller 10 determines whether a predetermined number of sheets of unprinted paper have been read (S12). If the predetermined number of sheets of paper have not been read (S12: NO), the flow returns to S11 and repeats the processing. The predetermined number of sheets of paper may be about 3 to 5, for example. This is because the quality of commercially available paper is high and there are few paper defects per brand, and even if there are defects, there is little variation in the frequency of appearance among papers. Needless to say, more unprinted papers may be read depending on papers used, a brand or a production lot of the paper, etc.

In S12, when the predetermined number of sheets of paper has been read (S12: YES), the controller 10 generates defect information, which will be described later, from image information of the predetermined number of sheets of unprinted paper stored in the storage 20, and stores the generated defect information in the storage 20 (S13).

Thereafter, if there is a print instruction, the controller 10 conveys one sheet of paper S from the paper feeder 50 to the image former 30, and executes printing in the image former 30 (S14).

The controller 10 conveys the printed paper to the reader 60, causes the reader 60 to read the printed paper, and stores the obtained image information in the storage 20 (S15).

Subsequently, the controller 10 determines the quality of the printed paper on the basis of the defect information stored in the storage 20 (S16). The controller 10 stores the determination result in the storage 20 and displays the result on the operation display 55. As for the storing processing, it is preferable to store determination results separately for good products and defective products. Meanwhile, the display processing may be performed only when a defective product is generated. In a case where a defective product is generated, the printing operation may be stopped at that point, and a warning may be displayed on the operation display 55. In addition to stopping the display or the printing, the paper may be ejected to a purge tray for purging defective products. In this case, all the papers that are in the upstream from the defective product may be further ejected to the purge tray.

Thereafter, when printing of the input print job is completed (S17: YES), the controller 10 terminates the processing. On the other hand, if printing of the print job has not been completed (S17: NO), the controller 10 returns to S14 and continues the processing. If a defective product has been purged, printing is performed again from the page after the defective product.

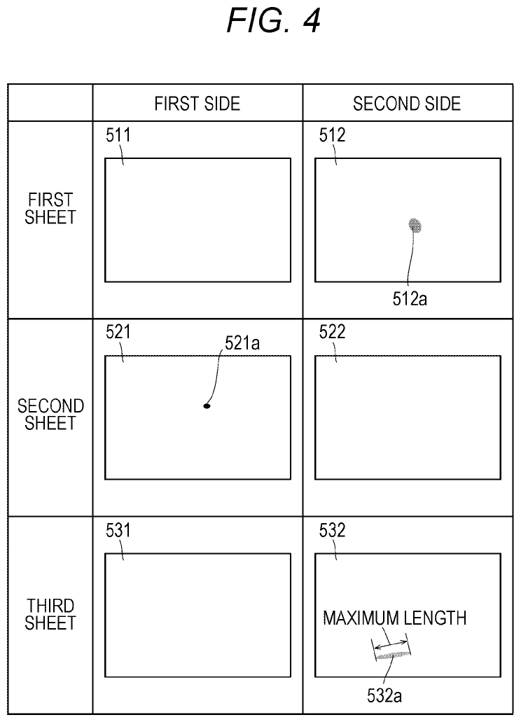

Defect information will be described. FIG. 4 is an explanatory diagram for explaining an exemplary defect present on unprinted paper. Here, a case where both sides of three sheets of unprinted paper are read will be described. In FIG. 4, a surface facing upward during conveyance is a first side, and a surface facing downward during conveyance is a second side.

No defect is detected on a first side 511 of a first sheet of paper. On the other hand, a defect 512a like as a stain is detected on a second side 512.

A defect 521a like as point scratch is detected on a first side 521 of a second sheet of paper. On the other hand, no defect is detected on a second side 522.

No defect is detected on a first side 531 of a third sheet of paper. On the other hand, a defect 532a like as a stain is detected on a second side 532.

Detection of defects is performed by the controller 10. For example, the controller 10 detects a defect by comparison with a reference white plate. For example, the density of the reference white plate is stored in the storage 20 in advance. Then, the controller 10 acquires a difference between the density of each pixel of the read unprinted paper (output value of each pixel from a scanner, the same applies hereinafter) and the stored density of the reference white plate, and a pixel is determined to be defective when the differential value exceeds a threshold value. The threshold value in this case is set depending on the whiteness of the paper, for example. Alternatively, using a fixed threshold value, the density of the reference white plate having different whiteness may be stored in advance, a defect may be detected by reading the density of a reference white plate matching the whiteness of paper used.

As another approach to detect a defect, for example, an average value of the density of respective pixels of the entire read unprinted paper is derived, and a difference between the average value and the density of each pixel is obtained. Then, a pixel a differential value of which is higher than a threshold value is determined to be defective. The threshold value in this case may be a predetermined value. Alternatively, statistics of the density of all pixels may be acquired to set a value such as 3σ or 2σ as the threshold value.

Then, the controller 10 obtains the density and the size of the detected defect. First, the controller 10 acquires a differential value of a pixel having the maximum value within a range, in which pixels having been detected as defects are continuous, as the density of the defect. The differential value here refers to a differential value from the density of the above-described reference white plate or a differential value from the average value of the density of respective pixels. In addition, the controller 10 regards the range, in which pixels having been detected as defects are continuous, as one defect and acquires the number of the continuous pixels (maximum length) as the size of the defect (see the defect 532a on the third sheet of paper illustrated in FIG. 4). Alternatively, the controller 10 may acquire the number of all the pixels that are continuous (that is, the area of the defect) as the size of the defect.

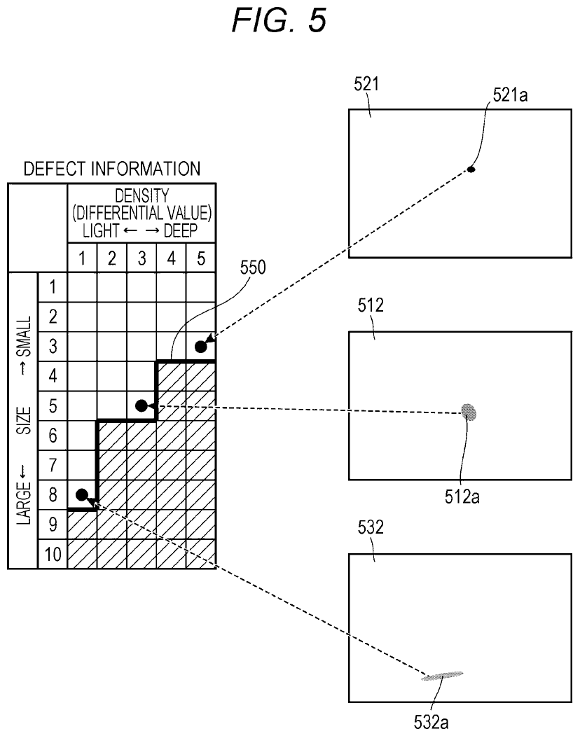

FIG. 5 is an explanatory diagram explaining exemplary defect information. The defect information illustrated in FIG. 5 is a matrix with the differential value of density represented on the horizontal axis and the size represented on the vertical axis. In FIG. 5, each of the defects illustrated in FIG. 4 is arranged in association with this matrix.

In the defect information, the differential value of density (hereinafter also simply referred to as density) and the size of defects are arranged in the matrix illustrated in FIG. 5, and a determination reference line obtained from the density and the size is used as determination criteria.

As illustrated in FIG. 5, the defect 512a on the second side 512 of the first sheet has a density of 3 and a size of 5. The defect 521a of the first side 521 of the second sheet has a density of 5 and a size of 3. The defect 532a on the second side 532 of the third sheet has a density of 1 and a size of 8.

A determination reference line 550 obtained on the basis of such a matrix is set to a boundary between the respective values of the density and the size of the defects arranged in the matrix and subsequent values thereof as illustrated in FIG. 5.

When the density and the size of a defect detected by reading a sheet of printed paper do not exceed this determination reference line, that is, when being outside the hatched area in FIG. 5, it is determined as a good product. When the determination reference line 550 is exceeded, that is when being within the hatched area in FIG. 5, it is determined as a defective product.

Determination of a defect on a sheet of printed paper is performed by, for example, comparing the density of each pixel in image data to be printed with the density of each pixel in the image which is read after printing, and determining a pixel, having the differential value higher than a predetermined threshold value, as being defective. The threshold value in this case is stored in the storage 20 as determination criteria for an image defect after printing based on, for example, experiments or experiences. Determination of an image defect after printing is not limited to such an approach, and various approaches may be used.

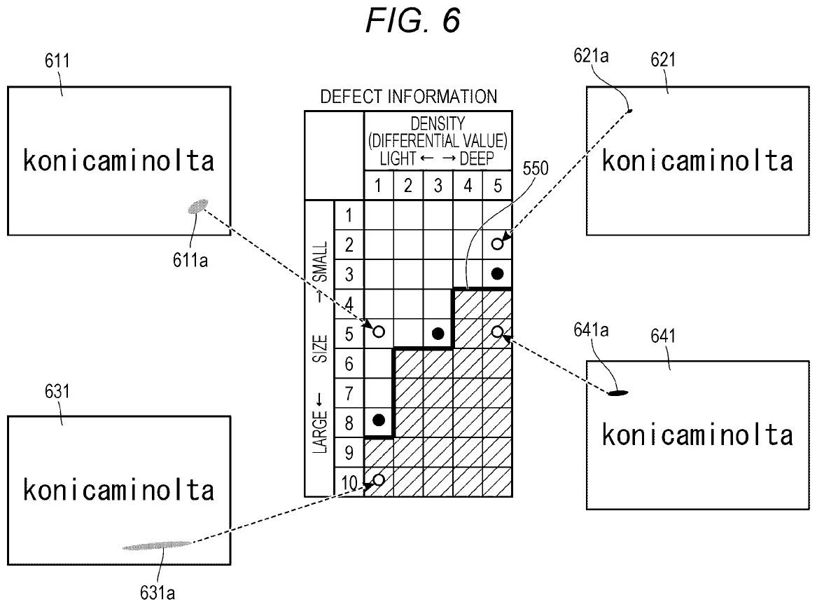

FIG. 6 is an explanatory diagram for explaining an example how to determine whether a printed matter is a good product or a defective product. FIG. 6 illustrates an example of determination based on the defect information illustrated in FIG. 5.

A first printing example 611 has a defect 611a like a stain. When the density and the size of the defect are applied to the defect information, since a density of 1 and a size of 5 do not exceed the determination reference line 550, the first printing example 611 is determined to be a good product.

A second printing example 621 has a defect 621a like a point scratch. When the density and the size of the defect are applied to the defect information, since a density of 5 and a size of 2 do not exceed the determination reference line 550, the second printing example 621 is determined to be a good product.

A third printing example 631 has a defect 631a like a stain. When the density and the size of the defect are applied to the defect information, since a density of 1 and a size of 10 do not exceed the determination reference line 550, the third printing example 631 is determined to be a defective product.

A fourth printing example 641 has a defect 641a like a stain. When the density and the size of the defect are applied to the defect information, since a density of 5 and a size of 5 do not exceed the determination reference line 550, the fourth printing example 641 is determined to be a defective product.

Note that the density has five levels and that the size has ten levels in this example; however, this is an illustrative example. For example, levels of the density can be set in the same manner as gradation values to be read by the scanners, or can be set to the number of gradations that is possible as a differential value of density. Similarly, levels of the size can be set to the same number of pixels of the scanners, or can be set to the number of pixels that is possible as the size of a defect.

Defect information using unprinted paper is preferably generated every time the brand of paper used is changed. It is also preferable that defect information once generated be stored in the storage 20 for each brand.

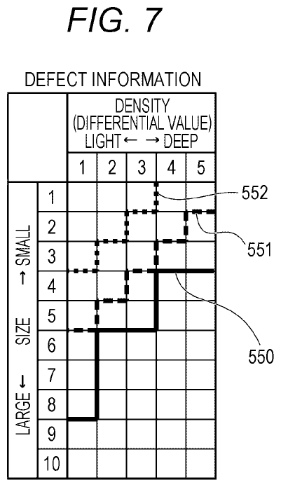

FIG. 7 is an explanatory diagram for explaining defect information generated for each brand of paper. FIG. 7 illustrates determination reference lines 550, 551, and 552 generated from unprinted paper of three brands A, B, and C, respectively. The determination reference line 550 for the brand A is the same as that in FIG. 5 described above. The storage 20 stores the determination reference lines 550, 551, and 552 for the three brands A, B, and C, respectively.

In the example illustrated in FIG. 7, the determination reference line 552 of the brand C is the strictest determination criteria since unprinted paper of the brand C has the fewest defects, and the determination reference line 550 of the brand A is the loosest determination criteria since unprinted paper of the brand A has the most defects.

When performing image inspection of printed paper, the controller 10 that has received a designation of a brand from a user performs determination of printed paper using the determination reference line of the brand (one of the determination reference lines 550, 551, and 552). For this purpose, the controller 10 may display, for example, a screen for prompting brand designation on the operation display 55 so that a brand is designated before image inspection or before printing is started.

Generating and storing defect information for each brand in this manner eliminates, if the brand is the same, the need to read unprinted paper to generate defect information each time the paper is replenished (or replaced), and thus the paper and the labor can be saved.

However, in a case where a printed matter is determined using defect information having been generated before as described above, there are cases where determination as a defective product is successive for a certain number of sheets depending on a replenished paper. In such a case, it is conceivable that the degree of defect (density or size) is different for the paper from which the defect information has been generated and for the replenished paper. In such a case, it is preferable to temporarily stop printing and to cause a predetermined number of sheets of replenished new unprinted paper to be read to generate defect information again. As causes for a difference in the occurrence of defects for the same brand, various factors can be considered such as a difference in production lots, a difference in the environment of locations for storing papers, and a difference in storage periods.

Note that defect information may be generated not for each brand but for each of various paper groups of the same brand such as different production lots or different packages.

As described above, according to the present embodiment, a sheet of unprinted paper is read, and information of a defect present on the paper is stored in the storage 20 as defect information. Then, since a defect present on a sheet of printed paper becomes clear from an image obtained by reading the printed paper by the reader 60, the quality determination is performed on the basis of the defect information stored in the storage 20. As a result, even when a defect equivalent to a defect that has originally been on the paper occurs during printing, the printed matter as a whole can be determined as a good product.

In particular, in the present embodiment, determination as a defective product is made only in a case where a defect present on a sheet of printed paper has a higher density or a larger size than those of the defect recorded in the defect information. As a result, even when a defect having a density and a size similar to or less than those of a defect that has originally been on the paper occurs during printing, it is possible not to determine as a defective product. Therefore, the present embodiment can reduce the number of wasteful defective determinations as compared to the related art since a defect equivalent to or less than a defect that has originally been on the paper is regarded as being allowable and a sheet of printed paper having such a defect is not determined as a defective product. Thus, it is possible to reduce waste of paper and toner or waste of reprint time. It is also possible to make a determination that meets the needs of a user who has selected the paper to be used for printing.

[Variations]

Hereinafter, an example in which the conveyance path of a sheet of unprinted paper is changed will be described as a variation of the embodiment. In each of the following variations, the configuration of each component other than the conveyance path for unprinted paper, generation of defect information, and defect determination of a sheet of printed paper are the same as those in the embodiment, and thus description thereof is omitted. In each of drawings for explaining the following variations, the conveyance path for a sheet of unprinted paper is indicated by a one-dot chain line that is bolder than other conveyance paths, and other conveyance paths are indicated by dotted lines as in FIG. 1.

(First Variation)

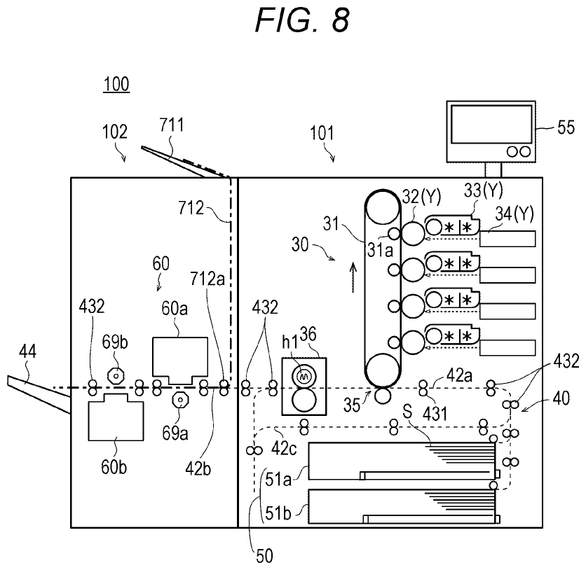

FIG. 8 is a schematic diagram illustrating a configuration of an image forming system 100 of a first variation.

In the image forming system 100 of the first variation, a manual paper feed tray 711 is included in an image inspection device 102, and a manual paper feed conveyance path 712 that conveys a sheet of unprinted paper from the manual paper feed tray 711 to the reader 60 is included. The manual paper feed conveyance path 712 includes conveyance rollers 712a. The manual paper feed tray 711 is a second paper feeder that feeds paper, and the manual paper feed conveyance path 712 is a conveyance that conveys paper from the manual paper feed tray 711 to the reader 60 of the image inspection device 102.

When a sheet of unprinted paper is read, the unprinted paper is set on the manual paper feed tray 711 and is directly conveyed to the reader 60 through the manual paper feed conveyance path 712 for reading. As a result, the unprinted paper does not pass through the image former 30, and thus no toner adheres to the unprinted paper. This prevents erroneous recognition as a defect with a toner adhering to the unprinted paper.

Note that the second paper feeder is not limited to the manual paper feed tray 711 included in the image inspection device 102. For example, the second paper feeder may be a paper feed tray included in the image forming apparatus 101. In this case, a manual paper feed conveyance path is included that conveys a sheet of paper directly from the paper feed tray included in the image forming apparatus 101 to the reader 60. In addition, in a case where a post-processing device for folding paper or a bundle of papers, attaching a cover, or forming a booklet is connected as an image forming system, an inserter for supplying paper or covers to be added to printed paper may be used as a manual paper feed tray to form a conveyance path for conveyance from the inserter to the reader 60. Furthermore, the image inspection device 102 may include a paper feed cassette, for example, below the reader 60 so that a sheet of unprinted paper can be conveyed directly from the paper feed cassette to the reader 60. This may also be the second paper feeder.

(Second Variation)

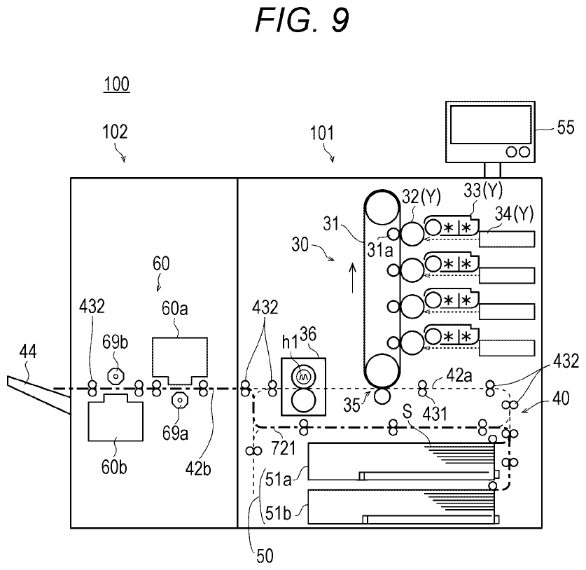

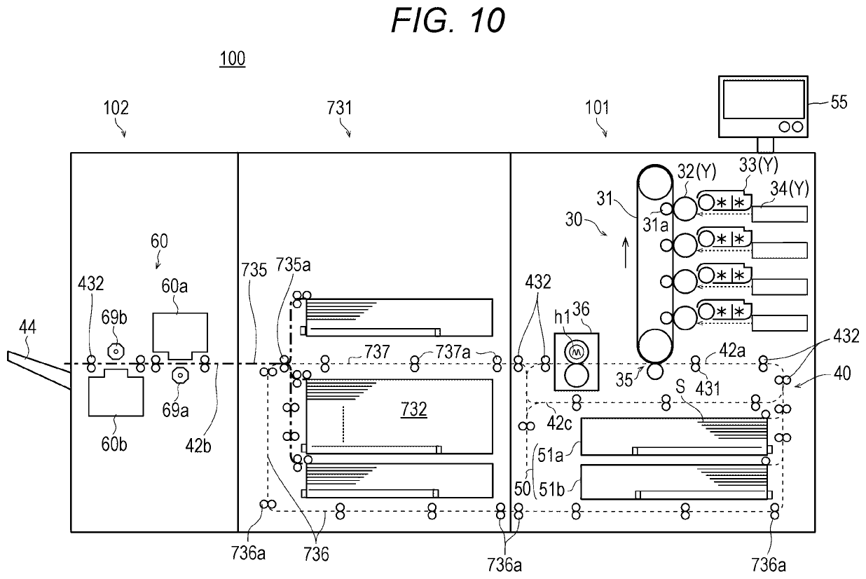

FIG. 9 is a schematic diagram illustrating a configuration of an image forming system 100 of a second variation.

The image forming system 100 of the second variation includes a bypass conveyance path 721 that conveys a sheet of unprinted paper from the paper feeder 50 to the reader 60 without passing through the image former 30. In the second variation, the bypass conveyance path 721 is formed in such a manner that the duplex printing conveyance path (see symbol 42c in FIG. 1) is extended to the paper feeder 50 and connected to the conveyance path 42b on the exit side of the fixer 36.

When reading a sheet of unprinted paper, the controller 10 causes the unprinted paper to be read by conveying the unprinted paper from the paper feeder 50 to the reader 60 through the bypass conveyance path 721. As a result, the unprinted paper does not pass through the image former 30, and thus no toner adheres to the unprinted paper. This prevents erroneous recognition as a defect with a toner adhering to the unprinted paper.

Note that the duplex printing conveyance path (see symbol 42c in FIG. 1) is used as a part of the bypass conveyance path 721; however, the present invention is not limited thereto. For example, a conveyance path for conveying a sheet of unprinted paper from the paper feeder 50 to the reader 60 without passing through the image former 30 may be provided completely separately from the paper feeding conveyance path 42a and the duplex printing conveyance path 42c (see FIG. 1) for image formation.

(Third Variation)

FIG. 10 is a schematic diagram illustrating a configuration of an image forming system 100 of a third variation.

In the image forming system 100 of the third variation, a paper feeding device 731 (third paper feeder) is provided between the image forming apparatus 101 and the image inspection device 102. The paper feeding device 731 includes a plurality of paper feed trays such as a paper feed tray 732 that can accommodate a large amount of paper.

The image forming system 100 of the third variation includes a first conveyance path 735 that conveys a sheet of unprinted paper from the paper feeding device 731 to the reader 60 of the image inspection device 102. The image forming system 100 of the third variation further includes a second conveyance path 736 that conveys a sheet of unprinted paper from the paper feeding device 731 to the image former 30 of the image forming apparatus 101. The image forming system 100 of the third variation further includes a third conveyance path 737 that conveys a sheet of printed paper from the image forming apparatus 101 to the reader 60 of the image inspection device 102. Each of the conveyance paths includes conveyance rollers 735a, 736a, and 737a (some symbols are omitted in FIG. 10).

When reading a sheet of unprinted paper, the controller 10 causes the unprinted paper to be read by conveying the unprinted paper from the paper feeding device 731 to the reader 60 through the first conveyance path 735. As a result, the unprinted paper does not pass through the image former 30, and thus no toner adheres to the unprinted paper. This prevents erroneous recognition as a defect with a toner adhering to the unprinted paper.

Meanwhile, for image formation, the controller 10 causes a sheet of unprinted paper to be conveyed from the paper feeding device 731 to the image former 30 through the second conveyance path 736 for printing.

When reading the printed paper, the controller 10 causes the printed paper to be read by conveying the printed paper from the image former 30 to the reader 60 through the third conveyance path 737.

(Fourth to Sixth Variations)

Fourth to sixth variations include a return conveyance path 741 that conveys a sheet of paper from the reader 60 to the image former 30.

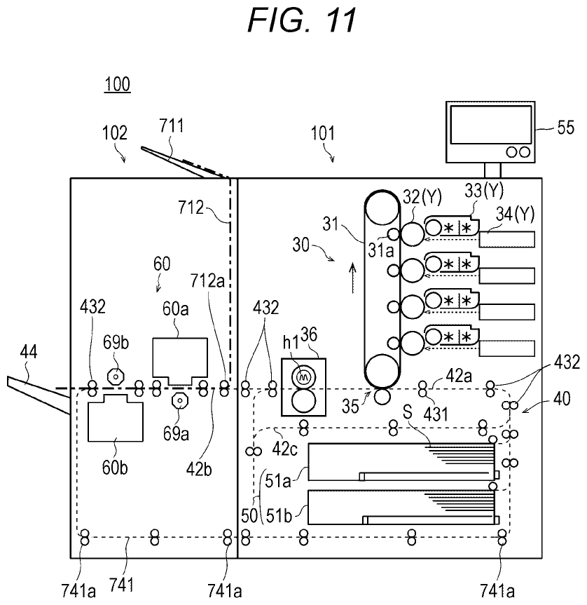

FIG. 11 is a schematic diagram illustrating a configuration of an image forming system 100 of a fourth variation. The image forming system 100 of the fourth variation is obtained by adding, to the image forming system 100 of the first variation described above, a return conveyance path 741 that conveys a sheet of unprinted paper after reading by the reader 60 to the image forming apparatus 101. The return conveyance path 741 includes a plurality of conveyance rollers 741a and conveys a sheet of paper.

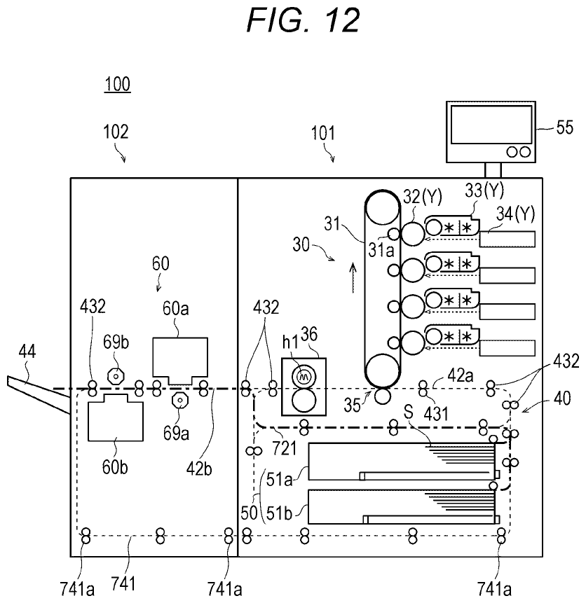

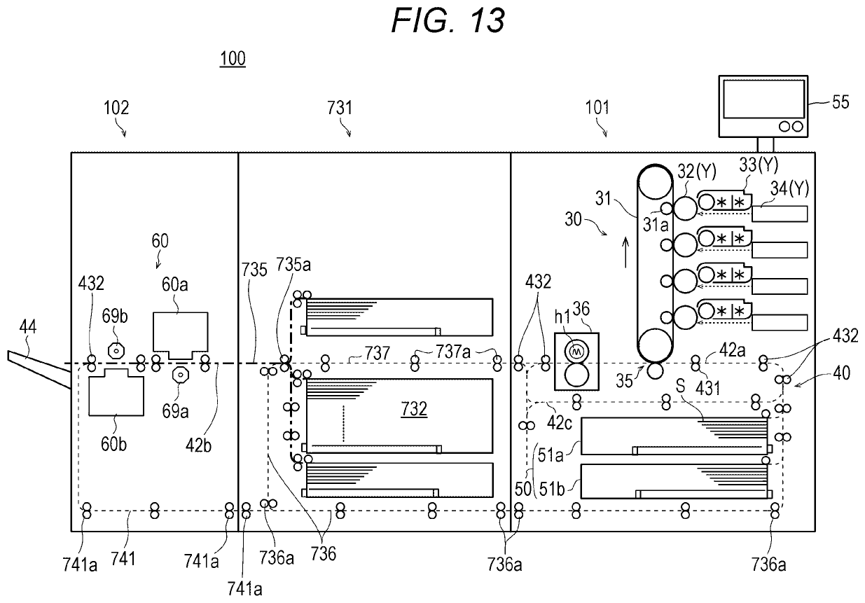

FIG. 12 is a schematic diagram illustrating a configuration of an image forming system 100 of a fifth variation. The image forming system 100 of the fifth variation is obtained by adding, to the image forming system 100 of the second variation described above, a return conveyance path 741 that conveys a sheet of unprinted paper after reading by the reader 60 to the image forming apparatus 101.

FIG. 13 is a schematic diagram illustrating a configuration of an image forming system 100 of a sixth variation. The image forming system 100 of the sixth variation is obtained by adding, to the image forming system 100 of the third variation described above, a return conveyance path 741 that conveys a sheet of unprinted paper after reading by the reader 60 to the image forming apparatus 101.

In the image forming systems 100 of the fourth to sixth variations described above, the controller 10 causes the reader 60 to read a sheet of unprinted paper to generate defect information, immediately conveys the paper, from which the defect information has been generated, along the return conveyance path 741, and causes the image former 30 to perform printing. Therefore, it is possible to immediately print on the unprinted paper without taking out the unprinted paper from which the defect information has been generated. Therefore, in the fourth to sixth variations, for example it is possible to generate defect information from all sheets of unprinted paper, to immediately print on those sheets of paper, and to perform quality determination. As a result, it is possible to perform quality determination of a sheet of printed paper more strictly on the basis of a defect that has originally been on a sheet of unprinted paper. Of course it is also possible to generate defect information from a predetermined number of sheets of unprinted paper for each paper group like in the embodiment.

Note that such a return conveyance path 741 may be included also in the image forming system 100 (see FIG. 1) of the embodiment.

Although the embodiments have been described above, the present invention is not limited to the embodiments or the variations. In the embodiment, the controller 10 of the image forming apparatus 101 uses the image inspection device 102 to perform processing including reading a sheet of unprinted paper, generating defect information, and quality determination of a sheet of printed paper based on the defect information (see the processing procedure illustrated in FIG. 3). Instead, for example, a controller dedicated to inspection may be included in the image inspection device 102, and the controller dedicated to inspection may perform processing including reading a sheet of unprinted paper, generating defect information, and quality determination of a sheet of printed paper based on the defect information (processing procedure illustrated in FIG. 3). In this case, paper conveyance, stopping printing during conveyance of a sheet of unprinted paper, separation of components in the image former, and the like are performed in cooperation with the controller 10 in the image forming apparatus 101. In addition, providing a controller dedicated to inspection in the image inspection device 102 enables processing by the image inspection device 102 alone. For example, it is possible that the image inspection device 102 alone reads a sheet of unprinted paper to generate defect information and then to perform quality determination on a sheet of paper that has been separately printed.

Although the density and the size of a defect are used as defect information in the embodiment, the number of defects may be used in place of or in addition to the above. The number of defects refers to the number of defects on a surface of a sheet of paper. Since the size of a sheet of paper is predetermined in a case of a normal cut paper, the density of defects may be derived from the number of defects in the paper size to obtain defect information.

The present invention can be further modified in various manners on the basis of the configurations described in the claims, and those modifications are also within the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming system including: an image forming apparatus comprising an image former that forms an image on a sheet of paper; and an image inspection device comprising a reader that reads the sheet of paper, the image forming system comprising:
a storage that stores information; and
a hardware processor that causes the reader to read a pre-image formation paper to store information of a defect present on the pre-image formation paper in the storage as defect information, and causes the reader to read a post-image formation paper on which the image has been formed by the image former to perform quality determination on a basis of the defect information.

2. The image forming system according to claim 1,
wherein the defect information includes information of a density and/or a size of the defect, and
the hardware processor determines as a defective product when a defect present on the post-image formation paper has a higher density or a larger size than those in the defect information.

3. The image forming system according to claim 1, wherein the hardware processor generates the defect information from a plurality of sheets of the pre-image formation paper.

4. The image forming system according to claim 1, wherein the hardware processor generates the defect information for each of paper groups including the pre-image formation paper from which the defect information has been generated and stores the defect information in the storage.

5. The image forming system according to claim 4, wherein the hardware processor uses a new sheet of the pre-image formation paper to generate the defect information again and stores the defect information in the storage in a case where more than or equal to a predetermined number of sheets of paper have been determined defective when quality determination has been performed on a basis of the defect information stored in the storage for each of the paper groups.

6. The image forming system according to claim 1, wherein the hardware processor stops image formation by the image former and conveys the pre-image formation paper when causing the reader to read the pre-image formation paper.

7. The image forming system according to claim 6,
wherein the image former comprises:
a photoreceptor on which an image is formed; and
a transfer body that transfers the image on the photoreceptor, and
the hardware processor separates the photoreceptor and the transfer body during conveyance of the pre-image formation paper.

8. The image forming system according to claim 6,
wherein the image former comprises:
a photoreceptor on which an electrostatic latent image is formed; and
a developer that develops the electrostatic latent image on the photoreceptor, and
the hardware processor separates the photoreceptor and the developer during conveyance of the pre-image formation paper.

9. The image forming system according to claim 1, further comprising:
a conveyance path that prevents the pre-image formation paper from passing through the image former,
wherein the hardware processor conveys the pre-image formation paper to the reader through the conveyance path that does not pass through the image former when causing the reader to read the pre-image formation paper.

10. The image forming system according to claim 9, wherein the conveyance path that prevents the pre-image formation paper from passing through the image former is a bypass conveyance path that allows the pre-image formation paper to be conveyed from a first paper feeder comprised in the image forming apparatus to the reader without passing through the image former.

11. The image forming system according to claim 9, wherein the conveyance path that prevents the pre-image formation paper from passing through the image former is a paper feed conveyance path that allows the pre-image formation paper to be conveyed from a second paper feeder that feeds paper to the reader without passing through the image former.

12. The image forming system according to claim 9, further comprising:
a third paper feeder disposed between the image former and the reader;
a first conveyance path that conveys the pre-image formation paper from the third paper feeder to the reader;
a second conveyance path that conveys the pre-image formation paper from the third paper feeder to the image former; and
a third conveyance path that conveys the post-image formation paper from the image former to the reader,
wherein when causing the reader to read the pre-image formation paper, the hardware processor causes the reader to read the pre-image formation paper by conveying the pre-image formation paper from the third paper feeder to the reader through the first conveyance path,
for image formation, the hardware processor causes the image former to form an image by conveying the pre-image formation paper from the third paper feeder to the image former through the second conveyance path, and
when causing the reader to read the post-image formation paper, the hardware processor causes the reader to read the post-image formation paper by conveying the post-image formation paper from the image former to the reader through the third conveyance path.

13. The image forming system according to claim 1, further comprising:
a return conveyance path that conveys the pre-image formation paper after being read by the reader from the reader to the image former,
wherein the hardware processor causes the image former to form an image by conveying the pre-image formation paper after being read by the reader from the reader to the image former through the return conveyance path.

14. An image forming method using an image forming system including:
an image forming apparatus comprising an image former that forms an image on a sheet of paper;
an image inspection device comprising a reader that reads the sheet of paper; and
a storage that stores information, the image forming method comprising:
(a) causing the reader to read a pre-image formation paper and storing information of a defect present on the pre-image formation paper in the storage as defect information; and
(b) causing the reader to read a post-image formation paper on which the image has been formed by the image former and performing quality determination on a basis of the defect information.

15. The image forming method according to claim 14,
wherein the defect information stored in the storage in the (a) includes information of a density and/or a size of a defect, and
it is determined in the (b) as a defective product when a defect present on the post-image formation paper has a higher density or a larger size than those in the defect information.

16. A non-transitory recording medium storing a computer readable image forming program causing a computer to execute the image forming method according to claim 14.

17. An image inspection device comprising:
a reader that reads a sheet of paper;
a storage that stores information; and
a hardware processor that causes the reader to read a pre-image formation paper to store information of a defect present on the pre-image formation paper in the storage as defect information, and causes the reader to read a post-image formation paper on which an image is formed to perform quality determination on a basis of the defect information.

18. The image inspection device according to claim 17,
wherein the defect information comprises information of a density and/or a size of the defect, and
the hardware processor determines as a defective product when a defect present on the post-image formation paper has a higher density or a larger size than those in the defect information.
